(19) United States
(12) Patent Application Publication
(10) Pub. No.: US 2007/0256564 A1
(43) Pub. Date: Nov. 8, 2007

(54) POSITIVE PRESSURE FILTRATION KIT APPARATUS AND METHOD

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/381,677

(22) Filed: May 4, 2006

(51) Int. Cl. B01D 46/00

(52) U.S. Cl. 96/222

(57) ABSTRACT

A positive pressure filtration kit (200) comprises a filtration unit (201), there being at least one filter (202) in the filtration unit and at least one air drawer (204) in the filtration unit. The filtration unit (201) is configured and arranged to sealingly fit into an existing opening of an enclosed structure, wherein ordinary course usage of the existing opening is for a purpose other than receiving a filtration unit. The at least one filter (202) in the filtration unit is capable of filtering out airborne particulate matter at least as small as 500 microns. The at least one air drawer (204) in the filtration unit draws air through the existing opening and through the at least one filter, wherein the air is drawn through the filtration unit at a sufficient rate to achieve and sustain a positive pressure environment within the enclosed structure.

### RELATED APPLICATIONS

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350; and

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS. AND METHOD as filed on 11/379,929 and having application number Apr. 24, 2006; the contents of which are fully incorporated herein by this reference.

### TECHNICAL FIELD

This invention relates generally to filtration units.

### BACKGROUND

Many people believe and trust that their government (local, regional, and/or national) will provide for them in the event of a catastrophic event such as an airborne biological and/or chemical attack. And, indeed, in the long view such is clearly a legitimate responsibility owed by any government to its citizens. That such is a consummation devoutly to be wished, however, does not necessarily make it so. To a large extent one may reasonably argue that governments have forsaken their responsibility to design, fund, implement, or even discuss an effective program capable of protecting large segments of their populations. Only a very few countries, such as Switzerland, make the ability to survive such events a discussed, funded, regulated, and supported part of the civil fabric.

Genuine concerns exist regarding the threat of airborne harmful biological and/or chemical agents. In the event of a biological or chemical attack or other incident, many citizens are ill-prepared to survive for any length of time. Most structures are not built airtight and allow significant exchange of air from inside and outside of the structure, thereby exposing occupants to tainted air. Bio-weapons filtrations systems exist, however, these systems are prohibitively expensive for the average citizen. In addition, these systems require extensive installation that can require modification of a structure's walls and roof. Such filtration systems are also permanent and cannot be removed when not in use.

Masks, such as respirators and related breathing devices, are also available. Masks and other breathing devices, however, are only a short-term solution in the event of a biological or chemical attack or incident. If an individual is required to wear a mask in order to survive, then the individual will not be able to eat, drink, or take medications orally while wearing the mask. Further, if a family or household relies on masks to survive an attack, masks must be available for each and every individual. Rather than being able to protect an entire roomful of people with one device, separate masks must be available for each individual. Between the high cost, extensive installation, and permanent nature of bio-weapons filtrations systems, however, and the short-term and inefficient nature of personal breathing devices, existing systems and products do not adequately address the survival needs of the average citizen.

### BRIEF DESCRIPTION OF THE DRAWINGS

The above needs are at least partially met through provision of the positive pressure filtration kit apparatus and method described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a schematic front detail view as configured in accordance with various embodiments of the invention;

FIG. 4 comprises a schematic front detail view as configured in accordance with various embodiments of the invention;

FIG. 5 comprises a schematic front detail view as configured in accordance with various embodiments of the invention;

FIG. 6 comprises a schematic front detail view as configured in accordance with various embodiments of the invention;

FIG. 7 comprises a schematic front detail view as configured in accordance with various embodiments of the invention;

FIG. 8 comprises a schematic perspective view as configured in accordance with various embodiments of the invention;

FIG. 9 comprises a schematic front detail view as configured in accordance with various embodiments of the invention;

FIG. 10 comprises a schematic side detail view as configured in accordance with various embodiments of the invention;

FIG. 11 comprises a schematic side detail view as configured in accordance with various embodiments of the invention;

FIG. 12 comprises a schematic side detail view as configured in accordance with various embodiments of the invention;

FIG. 13 comprises a schematic side detail view as configured in accordance with various embodiments of the invention;

FIG. 14 comprises a schematic side detail view as configured in accordance with various embodiments of the invention;

FIG. 15 comprises a block diagram as configured in accordance with various embodiments of the invention;

FIG. 16 comprises a block diagram as configured in accordance with various embodiments of the invention;

FIG. 17 comprises a flow diagram as configured in accordance with various embodiments of the invention; and

FIG. 18 comprises a schematic front detail view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a positive pressure filtration kit comprises a filtration unit, at least one filter in the filtration unit and at least one air drawer in the filtration unit. The filtration unit is configured and arranged to sealingly fit into an existing opening of an enclosed structure, wherein ordinary course usage of the existing opening is for a purpose other than receiving a filtration unit. The at least one filter in the filtration unit is capable of filtering out airborne particulate matter at least as small as 500 microns. The at least one air drawer in the filtration unit draws air through the existing opening and through the at least one filter, wherein the air is drawn through the filtration unit at a sufficient rate to achieve and sustain a positive pressure environment within the enclosed structure.

By one approach, the at least one filter can comprise multiple filters that can be arranged in a side-by-side configuration or in a stacked configuration. Further, the stacked filters may be the same type of filter or may be different types of filters. In addition, the at least one filter may be configured and arranged in the filtration unit to facilitate a user accessing the at least one filter during operation of the filtration unit while preventing exposure to unfiltered air. This configuration will allow a user to remove and replace the at least one filter with at least one replacement filter in a protected environment, without being exposed to unfiltered air.

The air drawer in the filtration unit may be, for example, electrically powered and/or human-powered by, for example, a crank. This, in turn, can facilitate a variety of powering options for the air drawer, wherein the appropriate powering option can be selected based on the conditions of the enclosed structure and the surrounding air pressure. The powering options may also be used in conjunction or independently of one another, to provide alternate or redundant power supplies.

Further, the positive pressure filtration kit may further comprise at least one air pressure meter that can be located inside and/or outside of the enclosed structure to facilitate monitoring and/or establishing the positive pressure environment. This facilitation can be accomplished by configuring and arranging the plurality of air pressure meters to automate airflow through the air drawer as a function of detected air pressure values.

So configured, these teachings permit a retrofittable, customizable, economically effective, and efficient filtration system that is configured to filter contaminants out of the air. The system also creates a positive pressure environment in an enclosed structure to thereby protect the occupants by keeping out tainted, unfiltered air. This filtration system is non-permanent and can be adapted to existing openings in a structure and is easily-installed.

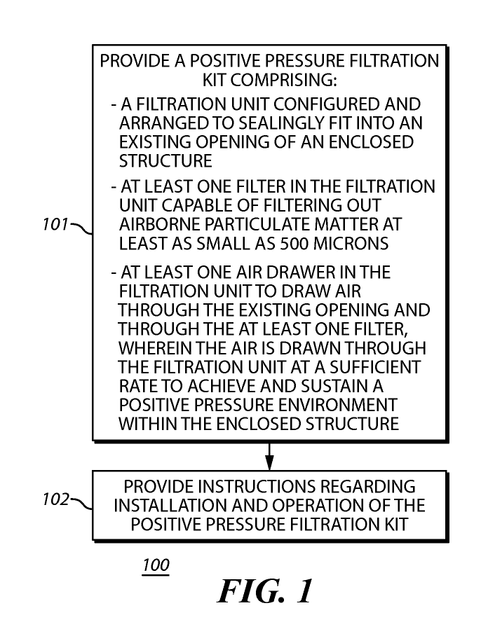

These and other benefits may become clearer upon making a thorough review and study of the following detailed description. Referring now to the drawings, and in particular to FIG. 1, a corresponding process 100 accommodates providing 101 a positive pressure filtration kit, wherein the positive pressure filtration kit comprises a filtration unit configured and arranged to sealingly fit into an existing opening of an enclosed structure. The positive pressure filtration kit further comprises at least one filter in the filtration unit capable of filtering out airborne particulate matter at least as small as 500 microns. Further, the positive pressure filtration kit comprises at least one air drawer in the filtration unit to draw air through the existing opening and through the at least one filter, wherein the air is drawn through the filtration unit at a sufficient rate to achieve and sustain a positive pressure environment within the enclosed structure.

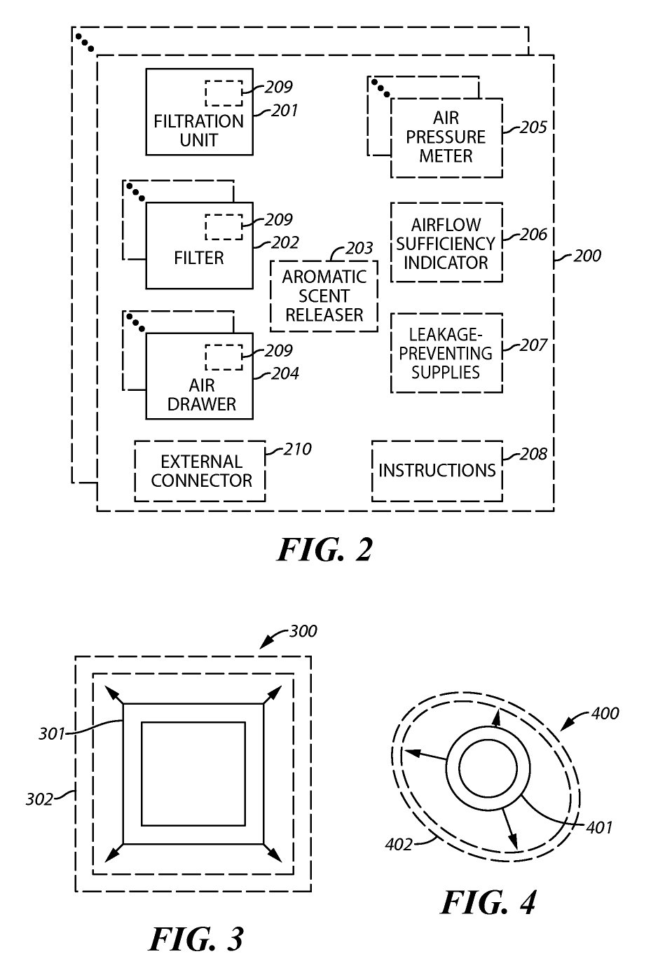

Referring now to FIG. 2, a positive pressure filtration kit 200 is shown. As stated above, the positive pressure filtration unit comprises a filtration unit 201, the filtration unit being configured and arranged to sealingly fit into an existing opening of an enclosed structure, wherein ordinary course usage of the existing opening is for a purpose other than receiving a filtration unit. The enclosed structure may comprise, for example, a building, a dwelling, a room, or a vehicle, to name but a few illustrative examples. The structure is also enclosed, such that the structure is generally surrounded or confined and has openings limited in number and size.

Further, the existing opening of the enclosed structure may be any hole, outlet, passage, vent, or orifice that previously exists in the structure and through which air may flow. The existing opening operates in its ordinary course usage for a purpose other than receiving a filtration unit. As an illustrative example, the existing opening may be a fireplace chimney opening located in a room of a house, wherein the fireplace is generally used in its ordinary course for burning flammables for heat and/or ambiance, and not for receiving a filtration unit. As another example, the existing opening may be a dryer vent opening that usually serves to vent exhaust air from a clothes dryer. Countless other examples exist.

Once the existing opening is identified, the filtration unit 201 will sealingly fit into the existing opening, such that generally all of the air flowing through the opening will pass through the filtration unit. The sealing fit may be accomplished, for example, by a variety of attachments that may be used to modify the size and/or shape of the filtration unit to thereby accommodate the size and/or shape of the existing opening. Attachment options can be provided to adapt any of a variety of specific types of existing openings for use with the filtration unit, such as, for example, a traditional dryer vent, a toilet vent pipe, a floor drain vent pipe, a bathroom drain vent pipe, a sink drain vent pipe, a window, a hot water gas exhaust vent, a boiler air intake vent, an air conditioning heat exchanger, a fireplace, a skylight, to name but a few examples. Further, to provide a sealing fit in the existing opening, the filtration unit 201 may have a sealing frame comprising at least one of: a variable size frame and a variable shape frame.

The variable size frame can be expanded or contracted to achieve the desirable size for sealingly fitting into the existing opening. Referring now to FIG. 3, a variable size frame 300 of a filtration unit is shown. The frame in this illustration is generally square-shaped and the size of the frame can be expanded or contracted to form a larger or smaller square-shaped frame according to the size of the existing opening. In FIG. 3, the frame is shown having an initial position 301, and is then shown expanding to a second position 302 that is larger than the initial position 301. Thus, the variable size frame 300 may vary in size to accommodate the size of the existing opening and, therefore, to sealingly fit into the existing opening such that generally all of the air flowing through the opening will pass through the filtration unit.

The variable shape frame can adjust in shape to accommodate the shape of the existing opening to, therefore, sealingly fit within the existing opening. Referring now to FIG. 4, a variable shape frame 400 of a filtration unit is shown. The variable shape frame 400 in this illustration is shown having an initial shape 401 that is generally circular. The variable shape frame 400 may then vary in shape to accommodate the size and shape of the existing opening. In FIG. 4, the variable shape frame is shown in the initial shape 401, and then the initial 401 shape is adjusted to a second shape 402 that would generally reflect the shape of the existing opening. Thus, the variable shape frame 400 may vary in shape to accommodate the shape of the existing opening and, therefore, to sealingly fit into the existing opening such that generally all of the air flowing through the opening will pass through the filtration unit.

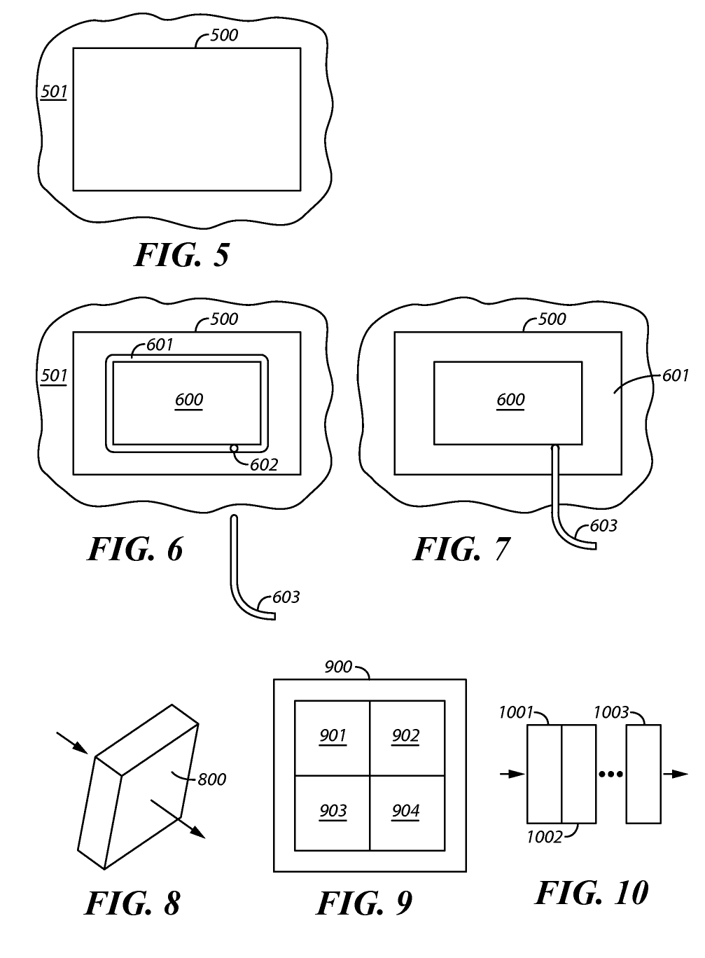

The sealing frame of the filtration unit may also comprise at least a partially inflatable frame. The inflatable frame may thus inflate within the existing opening to accommodate the size and/or shape of the existing opening and provide a sealing fit. Referring now to FIG. 5, an existing opening 500 is shown within the wall 501 of an enclosed structure. Referring now to FIG. 6, a filtration unit 600 is placed in the opening, wherein the filtration unit is surrounded by an inflatable frame 601. The inflatable frame 601 has an opening or valve 602 in which an inflation mechanism 603, such as an electric or human powered air pump, can be inserted to supply air to inflate the inflatable frame 601. Referring now to FIG. 7, the filtration unit 600 is shown having the inflatable frame 601 inflated to provide a sealing fit for the filtration unit 600 within the existing opening 500.

The positive pressure filtration kit may further comprise an external connector 210, as shown in FIG. 2, configured and arranged to pre-fit into the existing opening to accommodate receipt of the filtration unit. The external connector can, therefore, facilitate fast and easy installation of the filtration unit at such time when the filtration unit is needed. The external connector is configured and arranged to fit into the existing opening and may be installed in the opening at some pre-event time. The external connector is, therefore, pre-fit into the existing opening and may, optionally, remain in the opening up to and until such time as the filtration unit requires installation. At the time of installation of the filtration unit, such as at the time of an event or disaster, the external connector accommodates the simple receipt of the filtration unit. Pre-installing the external connector can thus accelerate the installation of the filtration unit. The external connector is also configured to allow the existing opening to continue to function for its ordinary course usage even upon installation of the external connector. Referring now to FIG. 18 for illustration, an existing opening 1801 is shown within the wall 1802 of an enclosed structure. Installed within the existing opening 1801 is an external connector 1803 that is configured and arranged to fit into the existing opening, and is also configured and arranged to accommodate easy receipt and installation of the filtration unit (not shown) in the installation opening 1804 of the external connector.

As shown in FIG. 2, the positive pressure filtration kit further comprises at least one filter 202 in the filtration unit capable of filtering out airborne particulate matter at least as small as 500 microns. The filter must filter out airborne particulate matter at least as small as 500 microns (roughly larger than the diameter of a human hair), but will generally be capable of filtering out smaller airborne particulate matter, such as a chemical or biological agents. Thus, toxins in the air will be filtered as the air flows through the filtration unit and into the enclosed structure. Referring now to FIG. 8, a single filter 800 is shown, with the arrows reflecting the direction of airflow through the filter. The filter may comprise at least one of:

a high-efficiency particulate air (HEPA) filter;

a charcoal filter;

a fiberglass filter;

a polyester filter;

a mechanical filter;

an electronic filter;

a hybrid filter;

a gas phase filter;

a ceramic filter;

a carbon filter,

to name but a few illustrative examples.

By one optional approach, the at least one filter may be scent-infused. Alternatively, the positive pressure filtration kit may further comprise an aromatic scent releaser 203, as shown in FIG. 2, that is positioned to permit air being expelled into the enclosed structure to be purposefully infused with a predetermined aromatic scent. Such an arrangement can provide for a pleasant aroma within the enclosed structure, and may further mask any unpleasant odors in the air.

The at least one filter of the positive pressure filtration kit may also comprise multiple filters. The multiple filters may be arranged in a side-by-side configuration. Referring now to FIG. 9, a filtration unit 900 is shown, having filters arranged in a side-by-side configuration. In this illustration, four filters (901, 902, 903 and 904) are used and are arranged in a single layer in the general shape of a square within the filtration unit. It should be noted that the multiple filters may comprise any number of filters that are arranged in a single layer in a side-by-side configuration, wherein the side-by-side configuration may occur in a horizontal and/or vertical direction.

The multiple filters may also be arranged in a stacked configuration. Referring now to FIG. 10, multiple filters (1001, 1002, and 1003) are shown. In this illustration, the filters are stacked, with the face of each filter in mating contact with the face of an adjacent filter. However, it should be noted that the filters may also be arranged in a stacking configuration with an offset or spacing between each filter. The stacking configuration provides multiples layers of filters for the air to pass through. The stacking configuration may also be used in conjunction with the side-by-side configuration, as discussed above.

By one optional approach, the multiple filters arranged in the stacked configuration may be a same type of filter. Conversely, the multiple filters arranged in the stacked configuration may be different types of filters. For example, the filter 1001 may be of a different type than the other filters 1002 and 1003 in the stack. The filters may be, for example, a combination of any of the varieties identified above. The use of different types of stacked filters may provide for more comprehensive filtration, wherein each filter works to filter out specific types and/or sizes of airborne particulate matter.

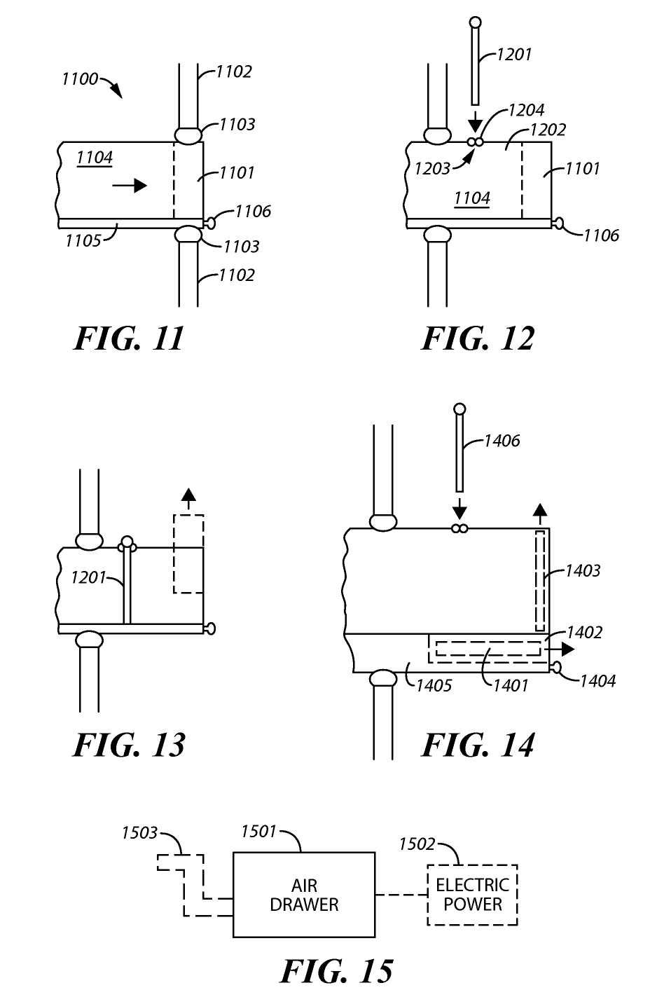

Further, the at least one filter may be configured and arranged in the filtration unit to facilitate a user accessing the at least one filter during operation of the filtration unit while preventing exposure to unfiltered air. Accessing the at least one filter may further comprise removing the at least one filter and replacing the at least one filter with at least one replacement filter. Many options are available for configuring and arranging the at least one filter to be accessed during operation of the filtration unit. An illustrative example of one such configuration is shown in FIG. 11. In this illustration, the filter 1101 is positioned in an air passage 1104. The filter 1101 is located within a portion of the filtration unit 1100 and is initially positioned between two wall portions 1102, with the wall portions having sealing portions 1103 that create a seal between the filter 1101 and the wall portions 1102. Air flows through the air passage 1104 and is then filtered through the filter 1101, wherein the filtered air then enters the enclosed structure. The filter 1101 and air passage 1104 are situated on a sliding platform 1105.

When the filter 1101 needs to be accessed, a user may pull a knob 1106 connected to the sliding platform. Pulling the knob 1106 will move the sliding platform 1105 forward, thereby moving the filter 1101 forward. Referring now to FIG. 12, the filter 1101 is moved forward when the sliding platform 1105 is pulled into an extended position. The user may then insert a stopper 1201 that is generally the size and shape of the air passage 11104. The stopper 1201 may be inserted through an opening 1203 of the top wall 1202 of the air passage 1104. The opening 1203 is sealed when the stopper 1201 is not used by two sealing tubes 1204, that also serve to prevent air from escaping through the opening 1203 when the stopper 1201 is inserted.

When inserted, the stopper 1201 will effectively stop the flow of air in the air passage 1104 so that air will not reach the filter 1101. Referring now to FIG. 13, the stopper 1201 is shown in its inserted position. A user may then access and remove the filter 1101 without being exposed to unfiltered air. Once the user removes the filter 1101, the user may replace the old filter with a new replacement filter.

The replacement filter may also be prepositioned within the filtration unit. By one optional approach, the configuration of FIG. 13 may further comprise a prepositioned replacement filter. As shown in FIG. 14, a replacement filter 1401 may be stored in a filter cavity 1402 that is positioned below a filter 1403. Therefore, a user may pull a knob 1404 to move the filter 1403 forward on a sliding platform 1405. The user will then insert a stopper 1406 to prevent the user from being exposed to unfiltered air and the user may then remove the existing filter 1403. The replacement filter 1401 may then be removed from the filter cavity 1402 and inserted in the place of the original filter 1403.

As mentioned above, and as shown in FIG. 2, the positive filtration kit also comprises at least one air drawer 204 in the filtration unit to draw air through the existing opening and through the at least one filter, wherein the air is drawn through the filtration unit at a sufficient rate to achieve and sustain a positive pressure environment within the enclosed structure. The air drawer serves to move the air through the filtration unit and the filter, however, it should be noted that the air is not being conditioned as it is being moved, such as by heating, cooling, or humidifying the air as it moves through the filtration unit.

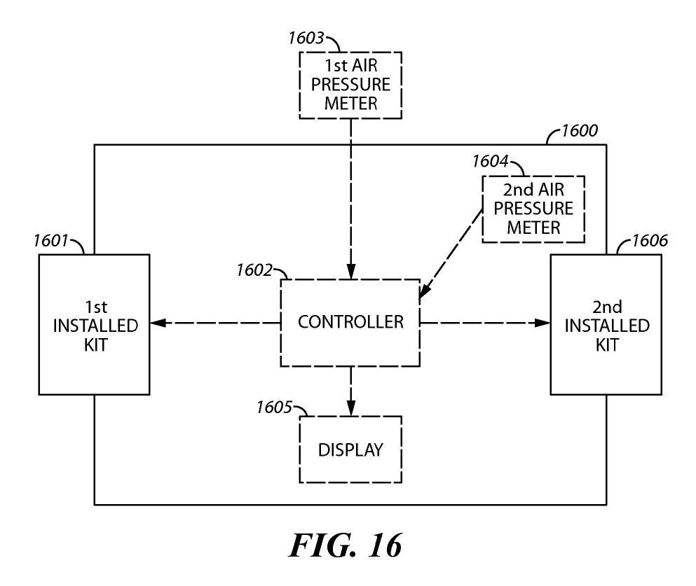

The at least one air drawer may be powered in any of a variety of ways. As shown in FIG. 15, the at least one air drawer 1501 may be electrically powered 1502. The electrical power may be provided, for example, by direct current sources and/or alternating current sources including but not limited to electrical power sourced by a generator, a battery, a solar cell, a thermoelectric source, and so forth. In addition, the at least one drawer may be powered, at least in part, by a human-powered crank 1503. The human-powered crank will allow a person to manually turn the crank to thereby operate the air drawer, and may comprise any of a variety of configurations, such as, for example, a handle or a peddle. Such a crank may be manipulable by hand, foot, or otherwise as may be appropriate in a given setting.

The at least one air drawer may also comprise multiple air drawers. The multiple air drawers may be used concurrently or may be used independently. The additional air drawers may operate as a back-up to a primary air drawer, or the air drawers may operate to supplement the other air drawers to thereby increase or decrease the flow of air as needed. The multiple air drawers may be the same type of air drawer, or may be different types of air drawers. Therefore, for example, an electrically powered air drawer may operate as the primary air drawer, while an additional air drawer powered by a human-powered crank may serve to supplement and/or back-up the electrically powered air drawer.

The at least one air drawer operates to draw air in through the filtration unit and it will preferably draw the air in at a sufficient rate to achieve and sustain a positive pressure environment within the enclosed structure. A positive pressure environment occurs when the air within the enclosed structure is at a higher pressure than the air outside of the structure. As a result, the pressure differential will serve to force air out of the structure, from the high pressure environment to the low pressure environment. As long as air is being forced out, then the opportunity for unfiltered or tainted air to enter the structure is significantly diminished. Therefore, a generally clean supply of air is provided for the occupants, with most of the air entering the structure being drawn in by the air drawer and then filtered.

At least one of the multiple air drawers may be configured and arranged to be controlled independently of at least one other of the multiple air drawers as needed to achieve and sustain the positive pressure environment. Referring now to FIG. 16, an enclosed structure 1600 is shown. The enclosed structure has a first positive pressure filtration kit 1601 installed. This positive pressure filtration kit 1601 may contain multiple air drawers (as shown in FIG. 2) and may also be connected to a controller 1602. At least one of these multiple air drawers may be configured and arranged to be controlled independently of at least one other of the multiple air drawers. Thus, the controller may monitor the positive pressure environment and put the independently controlled air drawer online or take the independently controlled air drawer offline as needed to achieve and sustain the positive pressure environment.

The positive pressure filtration kit may further comprise at least one air pressure meter 205, as shown in FIG. 2, to thereby monitor the air pressure conditions. The positive pressure filtration kit may further comprise at least one air pressure meter located inside the enclosed structure and at least one air pressure meter located outside of the enclosed structure to facilitate establishing the positive pressure environment. The air pressure meters may comprise a sensor and/or display. Referring again to FIG. 16, a first air pressure meter 1603 is located outside of the enclosed structure 1600 and a second air pressure meter 1604 is located inside the enclosed structure. The air pressure meters serve to provide air pressure readings both inside and outside of the enclosed structure.

Further, the at least one air pressure meter located inside the enclosed structure and at least one air pressure meter located outside of the enclosed structure may be configured and arranged to automate airflow through the air drawer as a function of detected air pressure values. Thus, the first air pressure meter 1603 and the second air pressure meter 1604 may be connected to the controller 1602, with the controller monitoring the air pressure values detected by the first air pressure meter 1603 and the second air pressure meter 1604. The controller 1602 may then communicate with the at least one air drawer in the first installed kit 1601 to increase or decrease the rate at which the air is drawn in to thereby achieve and sustain a positive pressure environment. The controller may also be optionally connected to a user interface, such as a display 1605, so that the user may view, for example, the air pressure readings or the air flow rates.

As another optional approach, air pressure meter sensors may be located inside and outside of the enclosed structure, with a single display showing both sets of readings. The sensors may detect the air pressure readings inside and outside of the enclosed structure, and the display will show both readings. Alternatively, the sensors may be connected to the controller, with the controller monitoring the detected pressure values. The controller may further communicate with the at least one air drawer to automate airflow through the air drawer as a function of detected air pressure values. The values may then be displayed on the display optionally coupled to the controller.

The positive pressure filtration kit may further comprise an airflow sufficiency indicator 206, as shown in FIG. 2. The airflow sufficiency indicator can detect the rate at which air is being drawn in through the filtration unit. The airflow sufficiency indicator can also work in conjunction with the controller, the at least one air drawer, and the air pressure sensors to regulate the flow of air to achieve and sustain a positive pressure environment.

A second positive pressure filtration kit may also be used in conjunction with the first positive pressure filtration kit, wherein the second positive pressure filtration kit has generally a same construction as the first positive pressure filtration kit. The first positive pressure filtration kit and the second positive pressure filtration kit may also be under common control. Referring now to FIG. 16, a second installed kit 1606 may also be installed in the enclosed structure. The first installed kit and the second installed kit may be in communication with a common controller, such that the controller may regulate the operation of both kits. Such an arrangement can facilitate the maintenance of the positive pressure environment, with the kits being able to work concurrently or independently of each other to filter the air and achieve the positive pressure environment. Further, the second installed kit may serve as a back-up to the first installed kit.

The positive pressure filtration kit may further comprise leakage-preventing supplies 207, as shown in FIG. 2, to mitigate leakage of air from the enclosed structure and to also prevent unfiltered air from entering the enclosed structure. The leakage-preventing supplies 207 may comprise any of a variety of materials for sealing the filtration unit within the existing opening or for sealing any other leaks, cracks, imperfections, or openings of the enclosed structure. The leakage-preventing supplies may comprise at least one of: an adhesive-bearing pliable material; a sprayable expanding foam; an elastic, pliable, adhesive material; an air-filled membrane; and a liquid-filled membrane. Viable candidates for leakage-preventing supplies may include, for example, latex, rubber, grease, caulk, silicone, or wax, to name a few illustrative examples.

Referring again to FIG. 1, the process further comprises providing 102 instructions regarding installation and operation of the positive pressure filtration kit. Therefore, the positive pressure filtration kit 200, as shown in FIG. 2, may further comprise instructions 208. The instructions may provide information regarding at least one of:
identification of viable candidate existing openings to receive the filtration unit;
conversion of existing opening into a viable candidate;
installation of the filtration unit in the existing opening;
providing a seal between the filtration unit and the existing opening;
sealing the enclosed structure;
operating the air drawer;
changing the filter;
uninstalling the filtration unit from the existing opening,
   to name but a few illustrative examples.

The instructions may be contained in the positive pressure filtration kit in any of a variety of ways, such as, for example, in the form of a manual. Further, the instructions may be at least partially displayed on at least one of the filtration unit, the filter, and the air drawer. As shown in FIG. 2, instructions 209 are shown as being optionally displayed on at least one of the filtration unit 201, the filter 202, and the air drawer 204.

The instructions may comprise, at least in part, audible instructions. The audible instructions can be supplied in any of a variety of forms. For example, the kit may provide a portion of the instructions on a CD or DVD that may be played to receive audible instructions. Or, as another illustrative example, the kit may include an mp3 player, or other audio player, with the instructions stored therein.

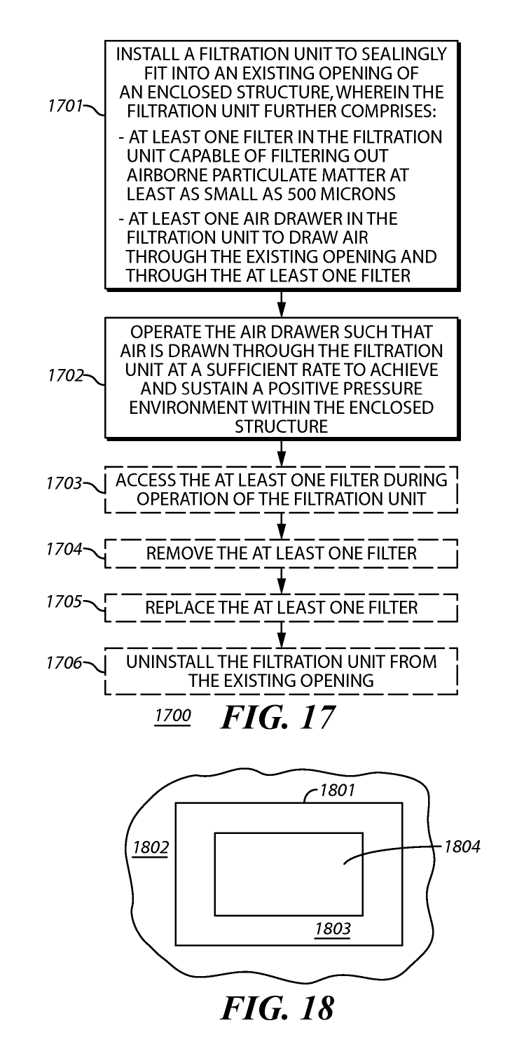

Referring now to FIG. 17, a corresponding process 1700 may comprise installing 1701 a filtration unit to sealingly fit into an existing opening of an enclosed structure. The filtration unit further comprises at least one filter in the filtration unit capable of filtering out airborne particulate matter at least as small as 500 microns and at least one air drawer in the filtration unit to draw air through the existing opening and through the at least one filter. The air drawer is then operated 1702 such that air is drawn through the filtration unit at a sufficient rate to achieve and sustain a positive pressure environment within the enclosed structure.

The filtration unit may also have a sealing frame (such as described above) wherein installing the filtration unit to sealingly fit into an existing opening of an enclosed structure comprises adjusting the sealing frame. The sealing frame thus acts to reduce air leakage around the filtration unit.

The at least one filter may be accessed 1703 during the operation of the filtration unit, wherein the at least one filter may then be removed 1704 and then replaced 1705, such as in the manner described above. The process 1700 may further comprise uninstalling 1706 the filtration unit from the existing opening.

It should also be noted that the while the positive pressure filtration system could be installed in an existing opening on a permanent basis, it is primarily designed to remain in a storage location until the time comes for the system to be used. The filtration system can then be removed from storage and quickly fitted to the existing opening at the time it is needed.

Thus, an economically efficient positive pressure filtration system is provided that not only effectively filters tainted air, but also creates a positive pressure environment to aid in preventing additional contaminated air from entering the enclosed structure. Such a system is highly retrofittable and may be adapted to any of a variety of existing openings within the enclosed structure without significant modifications. Occupants of the structure are thus able to significantly increase their chances of survival by having access to clean air during a biological or chemical attack or incident.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one illustrative example, a portable air compressor could be retrofitted to serve as a positive pressure filtration kit. Customized attachments could be provided for the air compressor to facilitate adapting the air compressor to act as a positive pressure filtration kit. The portable air compressor could have a hose attachment that is sealingly fitted on one end into an existing opening of an enclosed structure and is then attached at the other end to the intake point for the air compressor. The air compressor could then draw air in through the existing opening and the air would then pass through a filter, the filter being located outside of the enclosed structure, within the hose or attached at the intake point of the air compressor. The filtered air would then enter the enclosed structure to create a positive pressure environment. Such a configuration will thus protect an occupant of the structure. Further, the air compressor may also be covered in sound suppressing material to dampen the noise of the air compressor during operation.

I claim:

1. A positive pressure filtration kit comprising:
a filtration unit, the filtration unit being configured and arranged to sealingly fit into an existing opening of an enclosed structure, wherein ordinary course usage of the existing opening is for a purpose other than receiving a filtration unit;
at least one filter in the filtration unit capable of filtering out airborne particulate matter at least as small as 500 microns;
at least one air drawer in the filtration unit to draw air through the existing opening and through the at least one filter, wherein the air is drawn through the filtration unit at a sufficient rate to achieve and sustain a positive pressure environment within the enclosed structure.

2. The positive pressure filtration kit of claim 1 wherein the filtration unit has a sealing frame comprising at least one of:
a variable size frame;
a variable shape frame.

3. The positive pressure filtration kit of claim 2 wherein the sealing frame comprises an at least partially inflatable frame.

4. The positive pressure filtration kit of claim 1 wherein the at least one filter comprises at least one of:
a high-efficiency particulate air (HEPA) filter;
a charcoal filter;
a fiberglass filter;
a polyester filter;
a mechanical filter;
an electronic filter;
a hybrid filter;
a gas phase filter;
a ceramic filter;
a carbon filter.

5. The positive pressure filtration kit of claim 1 wherein the at least one filter is scent-infused.

6. The positive pressure filtration kit of claim 1 further comprising:
an aromatic scent releaser positioned to permit air being expelled into the enclosed structure to be purposefully infused with a predetermined aromatic scent.

7. The positive pressure filtration kit of claim 1 wherein the at least one filter comprises multiple filters.

8. The positive pressure filtration kit of claim 7 wherein the multiple filters are arranged in a side-by-side configuration.

9. The positive pressure filtration kit of claim 7 wherein the multiple filters are arranged in a stacked configuration.

10. The positive pressure filtration kit of claim 9 wherein the multiple filters arranged in the stacked configuration are a same type of filter.

11. The positive pressure filtration kit of claim 9 wherein the multiple filters arranged in the stacked configuration are different types of filters.

12. The positive pressure filtration kit of claim 1 wherein the at least one filter is configured and arranged in the filtration unit to facilitate a user accessing the at least one filter during operation of the filtration unit while preventing exposure to unfiltered air.

13. The positive pressure filtration kit of claim 12 wherein accessing the at least one filter further comprises:
removing the at least one filter;
replacing the at least one filter with at least one replacement filter.

14. The positive pressure filtration kit of claim 13 wherein the at least one replacement filter is prepositioned within the filtration unit.

15. The positive pressure filtration kit of claim 1 wherein the at least one air drawer is electrically powered.

16. The positive pressure filtration kit of claim 1 wherein the at least one air drawer is powered, at least in part, by a human-powered crank.

17. The positive pressure filtration kit of claim 1 wherein electrically powering the at least one air drawer comprises powering the at least one air drawer, at least in part, by solar power.

18. The positive pressure filtration kit of claim 1 wherein the at least one air drawer comprises multiple air drawers.

19. The positive pressure filtration kit of claim 18 wherein the multiple air drawers are the same type of air drawer.

20. The positive pressure filtration kit of claim 18 wherein the multiple air drawers are different types of air drawers.

21. The positive pressure filtration kit of claim 18 wherein at least one of the multiple air drawers is configured and arranged to be controlled independently of at least one other of the multiple air drawers as needed to achieve and sustain the positive pressure environment.

22. The positive pressure filtration kit of claim 1 further comprising at least one air pressure meter.

23. The positive pressure filtration kit of claim 22 wherein the at least one air pressure meter comprises at least one air pressure meter located inside the enclosed structure and at least one air pressure meter located outside of the enclosed structure to facilitate establishing the positive pressure environment.

24. The positive pressure filtration kit of claim 23 wherein the at least one air pressure meter located inside the enclosed structure and at least one air pressure meter located outside of the enclosed structure are configured and arranged to automate airflow through the air drawer as a function of detected air pressure values.

25. The positive pressure filtration kit of claim 1 further comprising an airflow sufficiency indicator.

26. The positive pressure filtration kit of claim 1 further comprising leakage-preventing supplies.

27. The positive pressure filtration kit of claim 26 wherein the leakage-preventing supplies comprise at least one of:
an adhesive-bearing pliable material;
a sprayable expanding foam;
an elastic, pliable, adhesive material;
an air-filled membrane;
a liquid-filled membrane.

28. The positive pressure filtration kit of claim 1 wherein the positive pressure filtration kit is a first positive pressure filtration kit, and wherein the first positive pressure kit further comprises a second positive pressure filtration kit having generally a same construction as the first positive pressure filtration kit.

29. The positive pressure filtration kit of claim 28 wherein the first filtration unit and the second filtration unit are under common control.

30. The positive pressure filtration kit of claim 1 further comprising:
instructions regarding at least one of:
identification of viable candidate existing openings to receive the filtration unit;
conversion of existing opening into a viable candidate;
installation of the filtration unit in the existing opening;
providing a seal between the filtration unit and the existing opening;
sealing the enclosed structure;
operating the air drawer;
changing the filter;
uninstalling the filtration unit from the existing opening.

31. The positive pressure filtration kit of claim 30 wherein the instructions are at least partially displayed on at least one of the filtration unit, the filter, and the air drawer.

32. The positive pressure filtration kit of claim 30 wherein the instructions comprise, at least in part, audible instructions.

33. The positive pressure filtration kit of claim 1 further comprising an external connector configured and arranged to pre-fit into the existing opening to accommodate receipt of the filtration unit.

34. A positive pressure filtration kit comprising:
a filtration unit, the filtration unit being configured and arranged to sealingly fit into an existing opening of an enclosed structure, wherein ordinary course usage of the existing opening is for a purpose other than receiving a filtration unit;
at least one filter means in the filtration unit for filtering out airborne particulate matter at least as small as 500 microns;
at least one air drawer means in the filtration unit for drawing air through the existing opening and through the at least one filter means, wherein the air is drawn through the filtration unit at a sufficient rate to achieve and sustain a positive pressure environment within the enclosed structure.

35. The positive pressure filtration kit of claim 34 wherein the at least one filter means is configured and arranged in the filtration unit to facilitate a user accessing the at least one filter means during operation of the filtration unit while preventing exposure to unfiltered air.

36. The positive pressure filtration kit of claim 34 wherein the at least one air drawer means comprises electrically powered air drawer means for drawing the air

37. The positive pressure filtration kit of claim 34 wherein the at least one air drawer means comprises human-powered air drawer means for drawing the air.

38. The positive pressure filtration kit of claim 34 further comprising means for mitigating leakage of air from the enclosed structure.

39. A method comprising:
providing a positive pressure filtration kit comprising:
a filtration unit, the filtration unit being configured and arranged to sealingly fit into an existing opening of an enclosed structure, wherein ordinary course usage of the existing opening is for a purpose other than receiving a filtration unit;
at least one filter in the filtration unit capable of filtering out airborne particulate matter at least as small as 500 microns;
at least one air drawer in the filtration unit to draw air through the existing opening and through the at least one filter, wherein the air is drawn through the filtration unit at a sufficient rate to achieve and sustain a positive pressure environment within the enclosed structure;
providing instructions regarding installation and operation of the positive pressure filtration kit.

40. The method of claim 39 wherein the instructions comprise information regarding at least one of:
identification of viable candidate existing openings to receive the filtration unit;
installation of the filtration unit in the existing opening;
providing a seal between the filtration unit and the existing opening;
operating the air drawer;
changing the filter;
uninstalling the filtration unit from the existing opening.

41. The method of claim 39 wherein the positive pressure filtration kit further comprises at least one air pressure meter inside the enclosed structure and at least one air pressure meter outside of the enclosed structure and wherein the instructions comprise information regarding using the at least one pressure meter inside the enclosed structure and at least one air pressure meter outside of the enclosed structure to facilitate establishing the positive pressure environment.

42. The method of claim 39 wherein the positive pressure filtration kit further comprises leakage-preventing supplies and wherein the instructions comprise information regarding how to use the leakage-preventing supplies to improve the air-tightness of the enclosed structure.

43. The method of claim 39 wherein the instructions are at least partially displayed on at least one of the filtration unit, the filter, and the air drawer.

44. The method of claim 39 wherein the instructions comprise, at least in part, audible instructions.

45. A method comprising:
installing a filtration unit to sealingly fit into an existing opening of an enclosed structure, wherein ordinary course usage of the existing opening is for a purpose other than receiving a filtration unit, wherein the filtration unit further comprises:
at least one filter in the filtration unit capable of filtering out airborne particulate matter at least as small as 500 microns;
at least one air drawer in the filtration unit to draw air through the existing opening and through the at least one filter;
operating the air drawer such that air is drawn through the filtration unit at a sufficient rate to achieve and sustain a positive pressure environment within the enclosed structure.

46. The method of claim 45 wherein the filtration unit has a sealing frame and wherein installing the filtration unit to sealingly fit into an existing opening of an enclosed structure comprises adjusting the sealing frame.

47. The method of claim 45 further comprising:
accessing the at least one filter during operation of the filtration unit;
removing the at least one filter;
replacing the at least one filter.

48. The method of claim 45 further comprising
uninstalling the filtration unit from the existing opening.
